(19) United States
(12) Patent Application Publication
(10) Pub. No.: US 2017/0324169 A1
(43) Pub. Date: Nov. 9, 2017

(54) ANTENNA APPARATUS

(71) Applicant: TRANS ELECTRIC CO., LTD., Changhua (TW)

(72) Inventor: Jeffrey HUANG, Changhua (TW)

(21) Appl. No.: 15/210,914

(22) Filed: Jul. 15, 2016

(30) Foreign Application Priority Data
May 6, 2016 (TW) 105206496

(51) Int. Cl. H01Q 15/16; H01Q 19/19

(52) U.S. Cl. CPC H01Q 15/161; H01Q 19/19

(57) ABSTRACT

An antenna apparatus is formed on a plane defined by perpendicular first and second axes. The antenna apparatus includes a primary radiating part, and two secondary radiating parts each including a section that extends along the first axis. The primary radiating part includes a first radiator having reflection symmetry about the second axis, a second radiator symmetrical to the first radiator with respect to the first axis, and two feed-in points The first radiator includes two lateral segments and a connector segment interconnecting the two lateral segments The lateral segments taper toward the first axis. A distance between the feed-in points is smaller than a length of a long edge of the connector segment.

### CROSS-REFERENCE TO RELATED APPLICATION

This application claims priority of Taiwanese Patent Application No. 105206496, filed on May 6, 2016.

### FIELD

The disclosure relates to an antenna apparatus, and more particularly to an antenna apparatus for digital television signals.

### BACKGROUND

Television signals are transmitted and processed digitally in order to efficiently utilize bandwidth resources and enhance image quality of a television. By configuring a structure of an antenna apparatus to generate a desired radiation pattern, the attenuation rate of electromagnetic waves in specific frequency bands is lowered, and the Signal-to-Noise Ratio (SNR) of a digital television signal received by the antenna apparatus is promoted. FIG. 1 shows a conventional antenna apparatus 700 for receiving digital television signals. The conventional antenna 700 is formed by bending a metal wire 710 into a shape of double rhombuses. Though the conventional antenna apparatus 700 has a simple structure and has a relatively wide reception bandwidth, the side lobes of the conventional antenna apparatus 700 in a diagram of the radiation pattern has a relatively high power level, so that radiation power of the main lobe is often diminished. Thus, the directivity of the conventional antenna apparatus 700 is adversely affected. Moreover, performance of the conventional antenna apparatus 700 in the frequency band between 470 MHz and 700 MHz for digital television signals has yet to be improved.

### SUMMARY

According to the disclosure, an antenna apparatus is formed on a plane that is defined by a first axis and a second axis which is perpendicular to the first axis. The antenna apparatus includes a primary radiating part and two secondary radiating parts. The primary radiating part includes a first radiator that is disposed on one side of the first axis and that has reflection symmetry about the second axis, a second radiator that is symmetrical to the first radiator with respect to the first axis, and two primary feed-in points that are disposed at the first axis. The first radiator includes two lateral segments respectively disposed on opposite sides of the second axis, and a connector segment interconnecting the two lateral segments. The connector segment is rectangular in shape and has a long edge which is parallel to the first axis. Each one of the lateral segments includes a connecting edge which is connected to the long edge of the connector segment, and a feed-in edge which is positioned at the first axis. Each of the primary feed-in points is formed on the feed-in edge of a respective one of the lateral segments The connecting edge is longer than the feed-in edge, and a distance between the primary feed-in points is smaller than a length of the long edge. Each of the two secondary radiating parts includes a first section that extends along the first axis, and a secondary feed-in point disposed at the first axis.

### BRIEF DESCRIPTION OF THE DRAWINGS

Other features and advantages of the disclosure will become apparent in the following detailed description of the embodiments) with reference to the accompanying drawings, of which:

FIG. 1 is a schematic view of a conventional antenna apparatus;

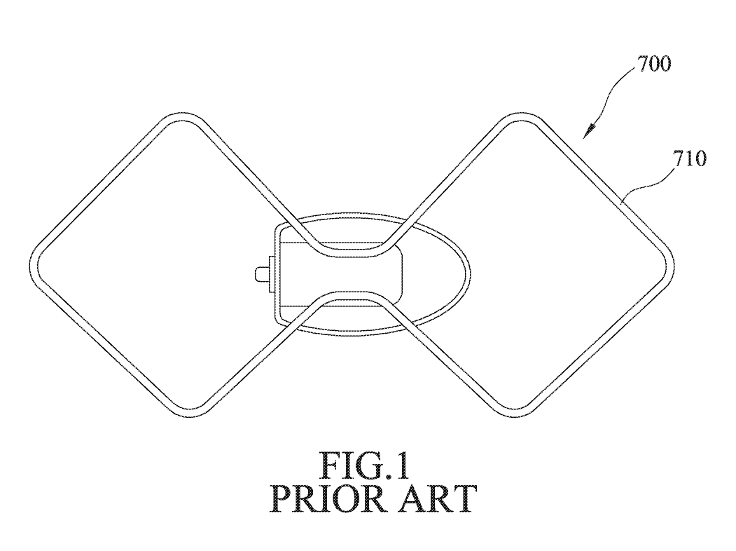

FIG. 2 is a schematic view of a first embodiment of an antenna apparatus of this disclosure;

FIG. 3 is a schematic view of a second embodiment of the antenna apparatus of this disclosure; and

FIG. 4 is a diagram illustrating attenuation rates of the conventional antenna apparatus and the first embodiment of the antenna apparatus of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements which may optionally have similar characteristics.

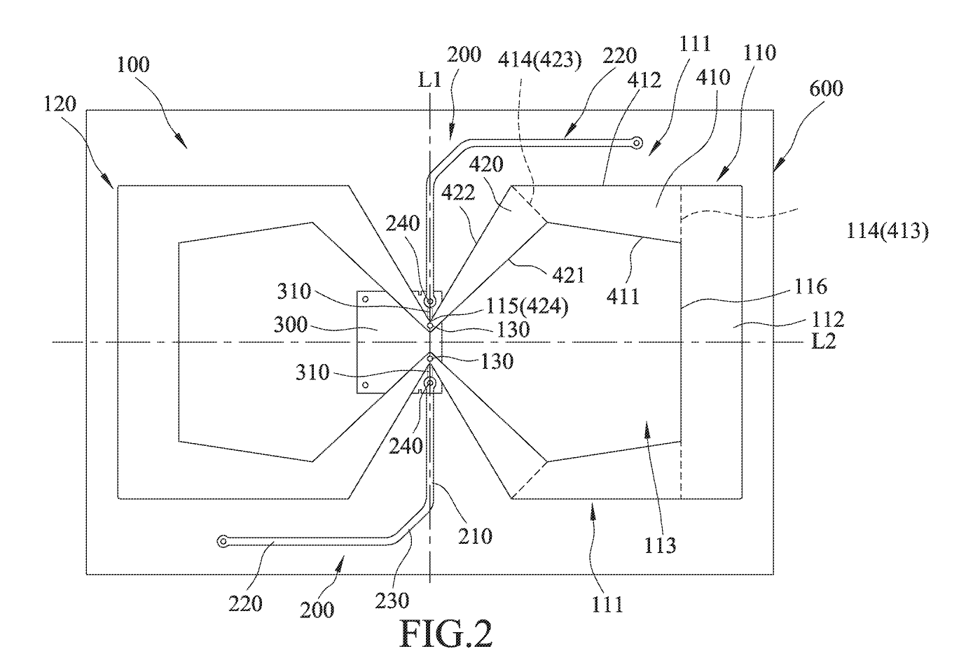

Referring to FIG. 2, a first embodiment of an antenna apparatus according to this disclosure is described below. The antenna apparatus is formed on a dielectric substrate 600 on which a first axis (L1) and a second axis (L2) that is perpendicular to the first axis (L1) are defined. The dielectric substrate 600 is made of insulating material, such as plastic, fiberglass, etc. The antenna apparatus includes a primary radiating part. 100, two secondary radiating parts 200, and a circuit module 300. The primary radiating part 100 and two secondary radiating parts 200 are formed on the dielectric substrate 600 by overlaying the dielectric substrate 600 with metal conductors (such as those of silver, copper, aluminum, etc.). According to different requirements, the dielectric substrate 600 may have flexibility or different colors. In other embodiments, the primary radiating part 100 and the two secondary radiating parts 200 of the antenna apparatus are formed on a plane (not shown) that is defined by the first axis (L1) and the second axis without overlaying the dielectric substrate 600.

The primary radiating part 100 includes a first radiator 110 that has a substantially enclosed shape, that is disposed on one side of the first axis (L1) and that has reflection symmetry about the second axis (L2), a second radiator 120 that is symmetrical to the first radiator 110 with respect to the first axis (L1), and two primary feed-in points 130 that are disposed ate, the first axis (L1). The first radiator 110 includes two lateral segments 111 respectively disposed on opposite sides of the second axis (L2), and a connector segment 112 interconnecting the two lateral segments 111. Wherein, the two lateral segments 111 and the connector segment 112 are configured to define an empty space 113.

The connector segment 112 is rectangular in shape and has a long edge 116 which is parallel to the first axis (L1). Each one of the lateral segments 111 includes a connecting edge 114 which is connected and adjacent to the long edge 116 of the connector segment 112, and a feed-in edge 115 which is positioned at the first axis (L1). Each of the primary feed-in points 130 is formed on the feed-in edge 115 of a respective one of the lateral segments 111.

Each one of the two secondary radiating parts 200 includes a first section 210 that extends along the first axis (L1), a second section 220 that extends along a direction parallel to the second axis (L2), a third section 230 that interconnects the first section 210 and the second section 220, and a secondary feed-in point 240 that is disposed at the first axis (L1) and that is electrically connected and adjacent to the first section 210. The second sections 220 of the two secondary radiating parts 200 are respectively disposed on opposite sides of the first axis (L1).

The circuit module 300 includes two matching inductors 310. Each of the two matching inductors 310 is disposed between a respective one of the secondary feed-in points 240 and a corresponding one of the primary feed-in points 130 which is near the secondary feed-in point (240).

Since the second radiator 120 is symmetrical to the first radiator 110 with respect to the first axis (L1), their shapes are identical to each other, and the naming of elements in the first radiator 110 corresponds to that in the second radiator 120. Moreover, since the first radiator 110 has reflection symmetry about the second axis (L2), shapes and elements of the two lateral segments 111 respectively correspond to each other. In this way, only one of the two lateral segments 111 of the first radiator 110 will be described hereinafter for the sake of brevity, and corresponding elements are denoted by the same numerals in the figures.

The primary radiating part 100 serves as a main structure for receiving signals. Characteristics and dimensions of the metal conductors forming the first radiator 110 and the second radiator 120 decide their impedances, which significantly affect the quality of the signals received by the antenna apparatus. Since this disclosure emphasizes the configurations and dimensions of the antenna apparatus, the shape and dimensions of the first radiator 110 are specifically described below.

In this embodiment, each one of the lateral segments 111 is divided into two segment portions 410 and 420 which are connected in series and which each has a convex quadrilateral shape. Thus, the first radiator 110 can be deemed as a combination of the plurality of segment portions 410 and 420, which are convex quadrilateral in shape, and the connector segment 112, which is rectangular in shape.

In order to decrease power level of side lobes so as to promote overall reception efficiency of the antenna apparatus, shapes and dimensions of the connector segment 112 and the segment portions 410 and 420 should be appropriately adjusted to yield desired impedances. In this way, when a high-frequency current which results from signal reception by the antenna apparatus flows to a shield layer of a coaxial cable connected to the primary feed-in points 130, by adjusting the impedances, the power level of the side lobes may be decreased.

In detail, the lateral segment 111 is divided into the two segment portions 410 and 420 by a bending point of the lateral segment 111. The segment portion 410 has an interior edge 411, an exterior edge 412, and two side edges 413 and 414 interconnecting the interior edge 411 and the exterior edge 412. The segment portion 420 has an interior edge 421, an exterior edge 422, and two side edges 423 and 424 interconnecting the interior edge 421 and the exterior edge 422.

The exterior edge 412 is parallel to the second axis (L2). The interior edge 411 and the long edge 116 form an obtuse angle. Thus, a distance between the interior edge 411 and the exterior edge 412 becomes shorter when the distance is more proximate to the first axis (L1). The side edge 413 serves as the connecting edge 114 which is connected and adjacent to the long edge 116. The side edge 424 serves as the feed-in edge 115. The side edge 414 is connected and adjacent to the side edge 423.

In addition, the segment portion 420 extends from the segment portion 410 toward the second axis (L2) such that the side edge 424 of the segment portion 420 is more proximate to the second axis (L2) than the side edge 423. The connecting edge 114 is longer than the feed-in edge 115.

The interior edges 411 and 421 of the segment portions 410 and 420 and the long edge 116 of the connector segment 112 are configured to define the empty space 113 which has a shape of a convex polygon. Since an angle formed by the interior edge 411 and the exterior edge 421 is an obtuse angle, not only an area of the first radiator 110 is decreased, but electrons accumulating at a corner formed by the interior edge 411 and the interior edge 421 are also decreased. Moreover, the impedance of the segment portions (410, 420) is related to the material and the dimensions thereof, so that the dielectric constant and the length of the segment portions (410, 420) are restricted to a certain range.

It should be noted that in this embodiment, each of the lateral segments 111 is divided into two segment portions, but the division of the lateral segments 111 should not be limited to the disclosure herein. In other embodiments, each of the lateral segments 111 may be divided into more than two segment portions. However, the more segment portions into which the lateral segment 111 is divided, the more parameters associated with dimensions and shapes should be considered.

The detailed dimensions are described below. A length of the interior edge 411 is between 70 mm (millimeters) and 110 mm. A length of the exterior edge 412 is between 110 mm and 160 mm. A length of the side edge 413 is between 30 mm and 60 mm. A length of the side edge 414 and that of the side edge 423 is between 20 mm and 45 mm. A length of the interior edge 421 is between 70 mm and 130 mm. A length of the exterior edge 422 is between 70 mm and 130 mm. A length of the side edge 424 is between 5 mm and 15 mm. A length of the long edge 116 is between 150 mm and 250 mm. A width of the connector segment 112 is between 20 mm and 45 mm. A summation of lengths of the first section 210, the second section 220, and the third section 230 ranges between 120 mm and 270 mm. The secondary radiating parts 200 substantially surround the primary radiating part 100. It should be noted that the connecting edge 114 is required to be longer than the feed-in edge 115, and a distance between the primary feed-in points 130 is required to be smaller than a length of the long edge 116 so as to effectively decrease the power of the side lobes.

In addition, each of the lateral segments 111 may be simplified to have a convex quadrilateral shape, and the secondary radiating parts 200 may be simplified to have a linear shape.

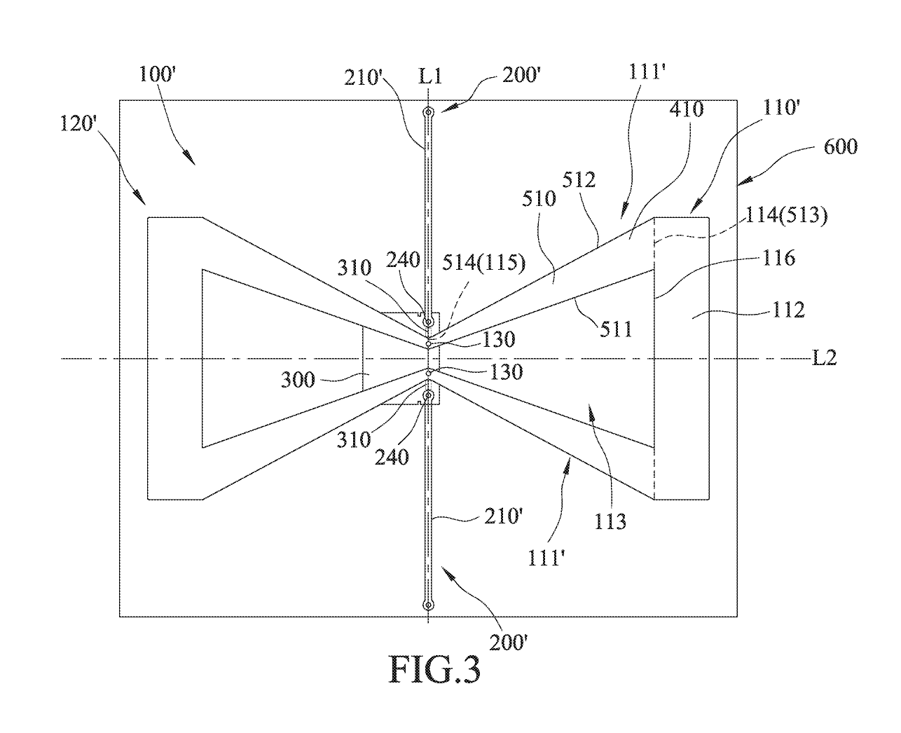

Referring to FIG. 3, a second embodiment of the antenna apparatus according to another aspect, of this disclosure is described below. The antenna apparatus is formed on the dielectric substrate 600. The antenna.

apparatus includes a primary radiating part 100′, two secondary radiating parts 200′, and a circuit module 300. The differences between the second embodiment and the first embodiment reside in the shapes of the primary radiating part 100′ and the secondary radiating parts 200′, and are explained hereinafter.

In the second embodiment, the primary radiating part. 100′ includes a first radiator 110′, a second radiator 120′, and two primary feed-in points 130. Because the second radiator 120′ is symmetrical to the first radiator 110′ with respect to the first axis (L1), their shapes are identical to each other, and the naming of elements in the first radiator 110′ corresponds to that in the second radiator 120′ Moreover, since the first radiator 110′ has reflection symmetry about the second axis (L2), only a portion of the first radiator 110′ will be described hereinafter for the sake of brevity, and corresponding elements are denoted by the same numerals in the figures.

The first radiator 110′ includes two lateral segments 111′, and a connector segment 112 which has a long edge 116. An empty space 113 is defined by the two lateral segments 111′ and the connector segment 112. Each one of the lateral segments 111′ is a segment portion 510 which has a convex quadrilateral shape. Each one of the segment portions 510 has an interior edge 511, an exterior edge 512, and two side edges 513 and 514 interconnecting the interior edge 511 and the exterior edge 512. The side edge 513 serves as a connecting edge 114 which is connected and adjacent to the long edge 116 of the connector segment 112. The side edge 514 serves as a feed-in edge 115 disposed on the first axis (L1). Wherein, an angle formed by the long edge 116 and the interior edge 511 of each one of the lateral segments 111, and an angle formed by the long edge 116 and the exterior edge 512 of each one of the lateral segments 111, are both acute angles. The angle formed by the interior edge 511 and the long edge 116 is greater than that formed by the exterior edge 512 and the long edge 116. The empty space 113 encircled by the interior edges 511 and the long edge 116 has a substantially triangular shape.

Each of the secondary radiating parts 200′ includes a first section 210′ extending along the first axis (L1) and has a linear shape.

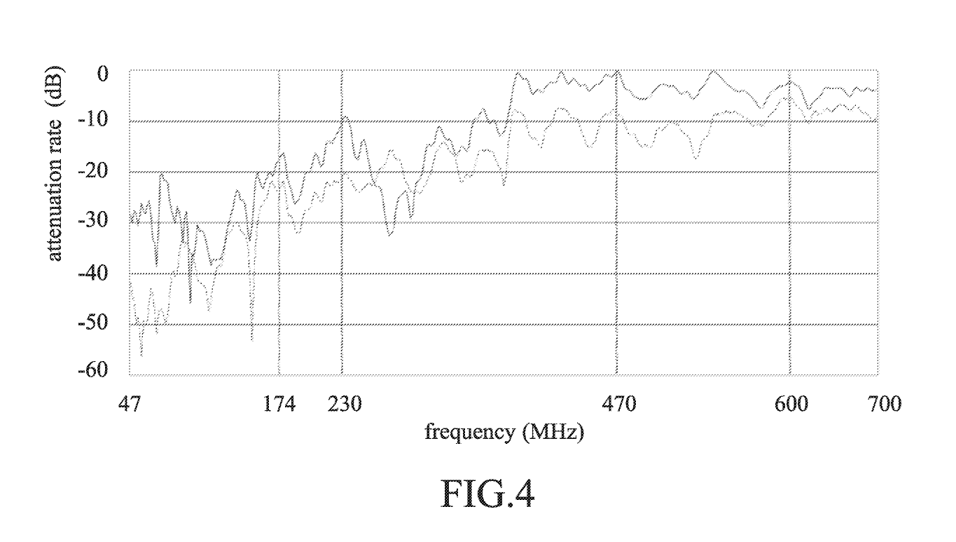

Referring to FIG. 4, a diagram illustrates attenuation rates of the conventional antenna apparatus (dotted line) and the first embodiment of the antenna apparatus of this disclosure in the frequency band ranging from 47 MHz to 700 MHz. In the frequency band of 470 MHz to 600 MHz, which is commonly used for digital television signals, performance of the antenna apparatus of the disclosure is substantially increased, which means the quality of signal reception is improved.

Furthermore, in the frequency band ranging from 174 MHz to 230 MHz for radio broadcasting or two-way radios, the performance is also improved.

In sum, the antenna apparatus improves performance in signal reception not only in the frequency band for digital televisions, but also in the frequency band for radio broadcasting or two-way radios.

In the description above, for the purposes of explanation, numerous specific details have been set forth in order to provide a thorough understanding of the embodiment(s) It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An antenna apparatus formed on a plane that is defined by a first axis (L1) and a second axis (L2) which is perpendicular to the first axis (L1), said antenna apparatus comprising
a primary radiating part including
a first radiator that is disposed on one side of the first axis (L1) and that has reflection symmetry about the second axis (L2),
a second radiator that is symmetrical to said first radiator with respect to the first axis (L1), and
two primary feed-in points that are disposed at the first axis (L1),
wherein said first radiator includes two lateral segments respectively disposed on opposite sides of the second axis (L2), and a connector segment interconnecting said two lateral segments, said connector segment being rectangular in shape and having a long edge which is parallel to the first axis (L1), each one lateral segments including a connecting edge which is connected to said long edge of said connector segment, and a feed-in edge which is positioned at the first axis (L1), each of said primary feed-in points being formed on said feed-in edge of a respective one of said lateral segments,
wherein said connecting edge is longer than said feed-in edge, and a distance between said primary feed-in points is smaller than a length of said long edge; and.
two secondary radiating parts each including a first section that extends along the first axis (L1), and a secondary feed-in point disposed at the first axis (L1).

2. The antenna apparatus as claimed in claim 1,
wherein each one of said lateral segments has a convex quadrilateral shape, and has an interior edge and an exterior edge each of which interconnects said connecting edge and said feed-in edge;
wherein, said interior edges of said lateral segments and said long edge of said connector segment are configured to define an empty space.

3. The antenna apparatus as claimed in claim 2, wherein an angle formed by said long edge and said interior edge of each one of said lateral segments and an angle formed by said long edge and said exterior edge of each one of said lateral segments are acute angles, and the angle formed by said interior edge and said long edge is greater than that formed by said exterior edge and said long edge.

4. The antenna apparatus as claimed in claim 1,
wherein each one of said lateral segments is divided into a plurality of segment portions which are connected in series and each of which has a convex quadrilateral shape, each one of said segment portions has an interior edge, an exterior edge, and two side edges interconnecting said interior edge and said exterior edge;
wherein said interior edges of said segment portions and said long edge of said connector segment are configured to define an empty space which has a shape of a convex polygon.

5. The antenna apparatus as claimed in claim 4,
wherein said segment portions into which each of said lateral segments is divided are two in number;
wherein, for one of said segment portions which is connected and adjacent to said connector segment, said exterior edge is parallel to the second axis (L2), one of said side edges serves as said connecting edge, a length of the other one of said side edges is greater than that of said feed-in edge, and an angle formed by said interior edge and said long edge is an obtuse angle.

6. The antenna apparatus as claimed in claim 1, wherein each one of said secondary radiating parts further includes a second section extending along a direction parallel to the second axis (L2) from said first section, said two second sections of said two secondary radiating parts are respectively disposed on opposite sides of the first axis (L1).

7. The antenna apparatus as claimed in claim 6, wherein each one of said secondary radiating parts further includes a third section connected between said first section and said second section, and a summation of length of said first section, said second section, and said third section ranges between 120 mm and 270 mm.

8. The antenna apparatus as claimed in claim 1 further comprising a circuit module, said circuit module including two matching inductors, each of which is disposed between a respective one of said secondary feed-in points and a corresponding one of said primary feed-in points which is near said secondary feed-in point.
